(19) United States
(12) Patent Application Publication
(10) Pub. No.: US 2006/0151506 A1
(43) Pub. Date: Jul. 13, 2006

(54) Vessel provided with a sealing ring

(75) Inventors: Jan Jacobus Matthijs Koppert, Delft (NL); Andy Debecker, Essen (BE)

Correspondence Address: SWANSON & BRATSCHUN L.L.C., 1745 SHEA CENTER DRIVE, SUITE 330, HIGHLANDS RANCH, CO, 80129, US

(73) Assignee: Advanced Lightweight Constructions Group B.V., Deflt (NL)

(21) Appl. No.: 10/169,529

(22) PCT Filed: Dec. 28, 2000
(86) PCT No.: PCT/NL00/00965

§ 371 Date: May 27, 2005

(30) Foreign Application Priority Data
Dec. 28, 1999 (NL) 1013970

(51) Int. Cl. F17C 1/00

(52) U.S. Cl. 220/581

(57) ABSTRACT

A vessel for containing a fluid is provided. A composite wall encloses the fluid chamber and is connected, at at least one location, to a shaft-like body which traverses the fluid chamber and extends through the composite wall. A sealing ring is further provided to which the composite wall is connected at the connection location(s) and is slidable around the shaft-like body, subject to being limited in at least one axial direction by a stop means.

The invention relates to a vessel, comprising a composite wall enclosing a fluid chamber and being, at least at one connecting location, connected to a shaft-like body traversing the fluid chamber and extending through the composite wall, which composite wall comprises a fluid-tight inner lining around which fibers are provided and which composite wall, at the at least one connecting location, is connected via a ring to the shaft-like body.

Such a type of vessel is known from practice and is often used for storing a gas or liquid supply. The composite wall is often built up of a relatively flexible plastic inner lining around which fibers are provided in a relatively stiff support layer. The advantage of this is, that the wall of the vessel, compared to a conventional steel wall, can be of a relatively light and low cost design, while having a comparable strength.

In the known vessel, at the connecting location, the composite wall is rigidly connected, via the ring, to the shaft-like body.

A drawback of the known vessel is that the sealing between the composite wall and the shaft-like body at the connecting location is often insufficiently reliable. In particular, the chance exists that, upon impact or shock loading of the vessel, the composite wall breaks off or becomes damaged at the location of the connection to the ring.

In practice, therefore, it has been found to be a problem to connect the fibers of the support layer and the inner lining of the composite wall, which is relatively flexible in comparison to the fibers, to the shaft-like body such that the sealing is guaranteed, while the chance of damage to the support layer and/or the inner lining is small.

The object of the invention is a vessel of the type mentioned in the preamble, in which the above mentioned problems are avoided. To that end, a vessel according to the invention is characterized in that the ring is designed as a sealing ring which is provided in an axially slidable and sealing manner around the shaft-like body and that stop means are provided for limiting in at least one axial direction the distance over which the sealing ring can be slid relative to the shaft-like body.

What is thereby achieved is that, while maintaining the sealing, an axial displacement of the fibers and/or the inner lining in relation to the shaft-like body is possible, so that tensions between the fibers and/or the inner lining and the shaft-like body due to displacement can be reduced. By using stop means it is achieved that damage to the composite wall by too large a displacement can be prevented.

By designing the stop means as cooperating press-on surfaces which are provided at the location of a connecting location on the sealing ring and the shaft-like body, respectively, it is achieved that fibers of the composite wall situated between the press-on surfaces can be clamped when the press-on surfaces are moved towards each other, for instance under pressure of fluid in the fluid chamber. This has as an advantage that possible play between the fibers during the pressing-on can be removed, so that a maximum number of enclosed fibers can be used for transmitting forces between the composite wall and the shaft-like body.

In a further embodiment, the fibers of the vessel are designed as tension-loadable cords, which are wound around the inner lining, and the shaft-like body which traverses the chamber comprises a tension body which extends through the composite wall at two connecting locations. The fibers are then preferably wound dry, i.e. without matrix material, around the inner lining, while, optionally, for protecting the fibers on the outside, a preferably elastomeric sealing layer can be provided.

With such a vessel, a fluid, for example LPG, can be stored under pressure. Via the inner lining the fluid pressure can then be transmitted to the sealing ring so that, subsequently, for instance with the help of the above described press-on surfaces, intermediately situated fibers can be clamped between the sealing ring and the shaft-like body. Especially in such a pressure vessel the operational safety and the transmission of forces of the connection between the composite wall and the shaft-like body are of particular importance.

It is noted that by dry-winding the fibers, it can be prevented that the composite wall becomes damaged by the fibers breaking loose from intermediately situated matrix material, for instance as a result of an impact or shock load to the vessel. Furthermore, by dry-winding the fibers, the manufacture of the vessel can be carried out quicker, since no time for hardening of the matrix material needs to be taken into account.

In a further advantageous embodiment, at at least a part of the connecting locations, the fibers and the inner lining of the composite wall are separately connected to the sealing ring. Thus, it is achieved that both the connection between the fibers and the sealing ring, and the connection between the inner lining and the sealing ring can be optimized for the function to be fulfilled by the connection, and that, for both connections, the nature of the materials to be connected can be taken into account. For instance, the fibers can be rigidly clamped into a position in which the clamped part of the fibers smoothly aligns with the non-clamped part of the fibers in order to reduce the risk of wear and breakage of the fibers, while the connection between the inner lining and the sealing ring can, for instance, be slidable, so that, while maintaining the sealing action, displacement of the inner lining relative to the sealing ring is possible. This is particularly advantageous when the inner lining, for instance during manufacture, shrinks or when the composite wall undergoes an impact or shock load.

Further advantageous embodiments are described in the subclaims.

It is noted that in this context, fluid should be understood to mean not only liquid or liquid solid matter, but also gas or vapor.

The invention will be further elucidated on the basis of an exemplary embodiment which is represented in the drawing. In the drawing:

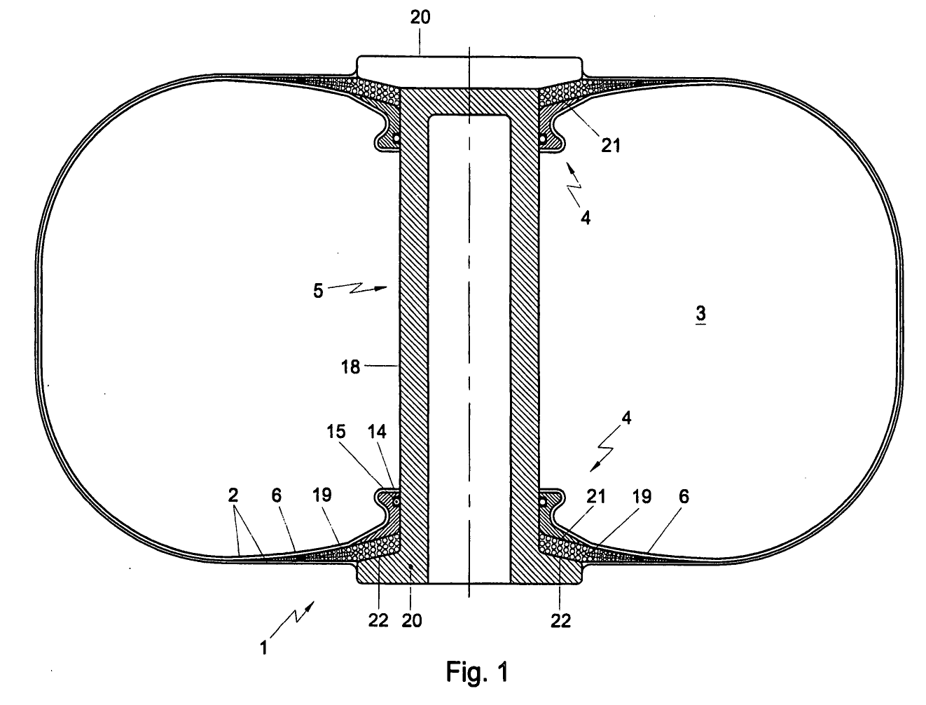

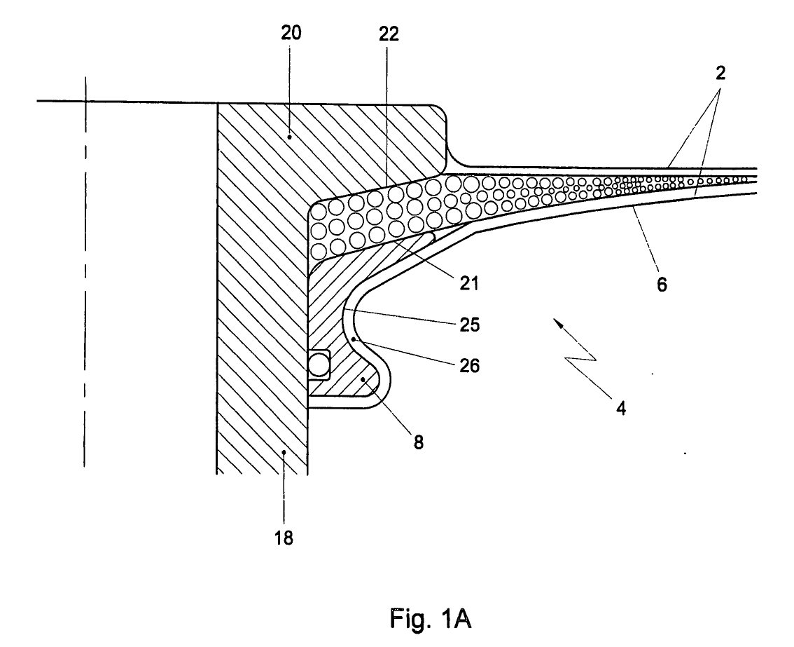

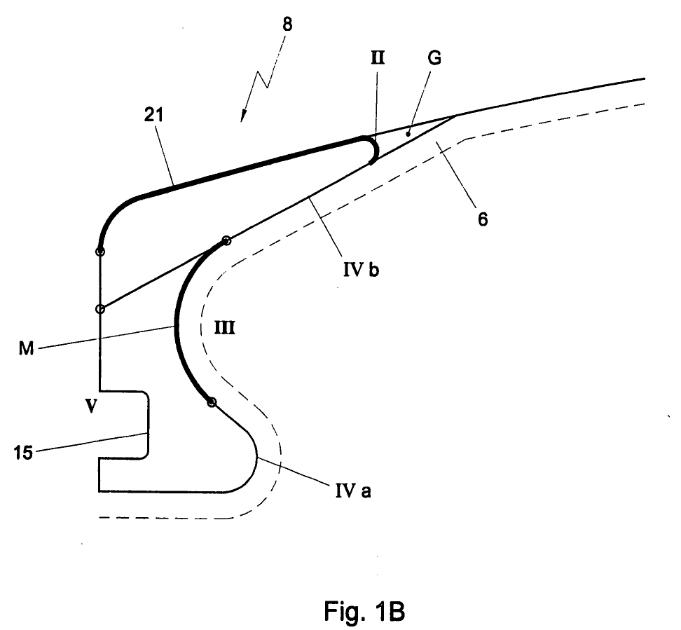

FIG. 1 shows a schematic cross section of the vessel;

FIG. 1A shows a detailed view of the connecting location of the vessel of FIG. 1; and

FIG. 1B shows a cross section of one side of the sealing ring of FIG. 1A.

It is noted that the Figures are only schematic representations of an advantageous embodiment. In the Figures, identical or corresponding parts are designated with the same reference numerals.

FIG. 1 shows a vessel 1. The vessel 1 comprises a composite wall 2 which encloses a fluid chamber 3. At two connecting locations 4 opposite each another, the composite wall 2 is connected to a shaft-like body 5 which traverses the fluid chamber 3. In the exemplary embodiment, the shaft-like body 5 is provided with a tension body 18 which, at the connecting locations, reaches through the composite wall 2, which is represented in detail in FIG. 1A. Near its end parts, the tension body 18 is provided with flange parts 20, extending radially outwards.

Referring to FIG. 1A, the composite wall 2 comprises a fluid-tight inner lining 6 around which fibers 7 are provided in a support layer. In this exemplary embodiment, the fibers 7 of the composite wall 2 are designed as tension-loadable cords 19 which are wound around the flexible, fluid-tight inner lining 6. The inner lining 6 is designed as a flexible core which, in relation to the layer of fibers 7, is relatively flexible, for instance a core of polyethylene, which, at least under its own weight load, retains its shape. The tension-loadable cords 19 are designed as strands of fibers, for instance glass, carbon and/or polyamide fibers which are bundled to a strand in the longitudinal direction. Preferably, one tension-loadable cord is wound around the inner lining 6 several times.

A vessel, the fibers of whose composite wall and a central shaft are tension-loadable, is known per se. For a detailed description of such a vessel and its manner of manufacture, reference is therefore made to the published European patent application 0 879 381.

At the connecting location 4, the composite wall 2 is connected to the shaft-like body 5 via a sealing ring 8 mounted around the shaft-like body 5 so as to be axially and freely slidable along the longitudinal axis A.

In an advantageous manner, the sealing ring 8 is provided with a cylindrical channel in which a cylindrical part of the shaft-like body 5 is received. The cylindrical channel can comprise one or more grooves 14 in which an O-ring 15 is received. Thus, it is achieved that in a simple manner a reliable, gas-tight sealing between the sealing ring 8 and the shaft-like body 5 can be realized. It will be clear that the sealing can also be realized in a different manner, for instance by a spring ring or an interference fit.

The vessel 1 is provided with stop means for limiting, in relation to the fluid chamber 3, the distance in axially outward direction along the tension body 18, over which the sealing rings 8 can be slid along the longitudinal axis of the tension body 18. The stop means comprise first press-on surfaces 21 which are provided on the sealing rings 8, and second press-on surfaces 22 provided on the flange parts 20. The first and second press-on surfaces 21, 22 are positioned such that, by axially and, in relation to the fluid chamber 3, outwardly displacing the sealing rings 8 along the longitudinal axis A, along the tension body 18, the press-on surfaces 21, 22 are moved towards each other while clamping the intermediately situated cords 19.

The press-on surfaces 21, 22 are provided with a curvature such that the fibers can be clamped into a position in which the clamped part of the fibers substantially smoothly aligns with the adjacent, non-clamped part of the fibers. This is represented in detailed view FIG. 1A. The cords 19 and the inner lining 6 are separately connected to the sealing ring 5.

When the fluid chamber 3 is provided with a fluid under pressure, the inner lining 6, while taking with it the sealing rings 8 attached thereto, will be pressed outward. The cords 19 are now tension-loaded and limit the outward displacement of the inner lining 6. The displacement of the sealing ring 8 is limited by cooperation of the first press-on surfaces 21 with the second press-on surfaces 22. In this manner, the cords 19 are clamped, free of play, in a position in which each of the clamped fibers can transmit force to the tension body 18.

The sealing ring 8 comprises a curved, throat-shaped contact surface 25 along which a correspondingly curved part 26 abuts in a sliding manner. By having the curved part 26 of the inner lining cooperate in a sliding manner with the throat-shaped contact surface 25, it is achieved that a good force transmission between the sealing ring 8 and the inner lining 6 is possible, while the inner lining 6, while maintaining the sealing action, can slide to some extent along the contact surface. This is particularly important when the vessel is put under pressure by filling the fluid chamber 3 with fluid.

Referring to FIG. 1B, the cross section of the sealing ring 8 is represented in detail therein. In the Figure, it can be seen that the first press-on surface 21 is provided with a curvature such that the cords 19, from the area G, where they separate from the inner lining 6, can align smoothly with the press-on surface 21. Near the area G, the contact surface 21 is provided with a rounding II, such that the chance of damage to the cords 19 and/or the inner lining 6 can be reduced.

The curved contact surface 25 is provided with a throat-shaped, concave curvature III, such that a middle part M thereof is situated closer to the longitudinal axis A of the shaft-like body 5 than are the adjacent side parts IVa, IVb. Thus, it is achieved that forces between the inner lining 6 and the sealing ring 8 can be transmitted better in the direction of the longitudinal axis A. Further, it is achieved that, with an inward deformation of the inner lining 6, i.e., towards the fluid chamber 3, it is rendered increasingly difficult for the inner lining to become detached from the contact surface 25 of the sealing ring 8. In this manner, it is achieved that the chance of damage to the inner lining 6 upon an inward movement of the composite wall 2 is small, while a good sealing remains ensured.

It is noted that this manner of sliding cooperation of the throat-shaped curved contact surface and the correspondingly curved part of the inner lining can be applied as such in an advantageous manner in vessels whose inner lining of the composite wall has to be fixedly connected to a body.

It will be clear that the invention is not limited to the exemplary embodiments described here, but that many variations are possible.

For example, other connections between the composite wall and the sealing ring are also possible, for instance glue connections. Also, the stop means can be designed differently, for instance such that they limit axial displacement in two directions.

Also, the fibers of the composite wall can be relatively short and these fibers can be received with mutually crossing orientations in a matrix material. Additionally, it is possible for the cords to consist of only one fiber. Also, the inner lining can be designed from different material than plastic, for instance from metal film.

Further, the vessel can comprise only one connecting location, for instance in an embodiment of the vessel in which the shaft-like body is designed as a carrier traversing the fluid chamber and which supports the inner lining at a side opposite the connecting location. Also, the vessel can comprise more than two connecting locations and the vessel can be provided with several tension bodies.

Such variants will be clear to the skilled person and are understood to fall within the scope of the invention as set forth in the following claims.

1. A vessel for containing fluid, comprising:
a composite wall enclosing a fluid chamber;
a shaft-like body which traverses the fluid chamber and extends through the composite wall, the composite wall being, at at least one connecting location, connected to the shaft-like body;
the composite wall comprising a fluid-tight inner lining around which fibers are provided;
a ring to which the composite wall is connected at the at least one connecting location to the shaft-like body, the ring being designed as a sealing ring and arranged in an axially slidable and sealing manner around the shaft-like body; and
stop means for limiting in at least one axial direction the distance over which the sealing ring can be slid relative to the shaft-like body.

2. A vessel according to claim 1, wherein the stop means comprises:
a first press-on surface being arranged on the sealing ring; and
a second press-on surface being arranged on the shaft-like body;
the first and second press-on surfaces being positioned such that through axial sliding of the sealing ring along the shaft-like body, the first and second press-on surfaces can be moved towards each other, thereby clamping the fibers of the composite wall therebetween.

3. A vessel according to claim 1, wherein:
the fibers are wound around the inner lining as one or more tension-loadable cords; and
the shaft-like body traversing the chamber comprises a tension body reaching through the composite wall at two locations situated opposite each other.

4. A vessel according to claim 2, wherein the second press-on surface extends at least partly along a radially outwardly extending flange part of the shaft-like body.

5. A vessel according to claim 1, wherein at least a part of the connecting locations the fibers and the inner lining of the composite wall are separately connected with the sealing ring.

6. A vessel according to claim 1, wherein the sealing ring comprises a curved, throat-shaped contact surface along which a correspondingly curved part of the inner lining slidably abuts.

7. A vessel according to claim 6, wherein the inner lining cooperates bondlessly with the contact surface.

8. A vessel according to claim 1, wherein:
the sealing ring comprises a cylindrical channel in which a cylindrical part of the shaft-like body is slidably received; and
the cylindrical channel comprises at least one groove in which an O-ring is received for sealing in a gas-tight manner the intermediate space between the channel and the cylindrical part of the shaft-like body.

9. A vessel according to claim 2, wherein the sealing ring comprises a curved, throat-shaped contact surface along which a correspondingly curved part of the inner lining slidably abuts.

10. A vessel according to claim 2, wherein:
the sealing ring comprises a cylindrical channel in which a cylindrical part of the shaft-like body is slidably received; and
the cylindrical channel comprises at least one groove in which an O-ring is received for sealing in a gas-tight manner the intermediate space between the channel and the cylindrical part of the shaft-like body.

11. A vessel according to claim 3, wherein at at least a part of the connecting locations the fibers and the inner lining of the composite wall are separately connected with the sealing ring.

12. A method of manufacturing a vessel for containing fluid, comprising the steps of:
providing a composite wall enclosing a fluid chamber with a fluid-tight inner lining;
providing fibers around the fluid-tight inner lining;
providing a shaft-like body which traverses the fluid chamber and extends through the composite wall;
arranging a sealing ring in an axially slidable and sealing manner around the shaft-like body;
connecting the composite wall at at least one connecting location to the shaft-like body with the ring; and
providing stop means for limiting in at least one axial direction the distance over which the sealing ring can be slid relative to the shaft-like body.

13. The method according to claim 12, wherein the step of providing the stop means comprises the steps of:
arranging a first press-on surface on the sealing ring;
arranging a second press-on surface on the shaft-like body;
positioning the first and second press-on surfaces such that through axial sliding of the sealing ring along the shaft-like body, the first and second press-on surfaces can be moved towards each other, thereby clamping the fibers of the composite wall therebetween.

14. The method according to claim 12, wherein the step of providing fibers comprises the step of winding the fibers around the inner lining as one or more tension-loadable cords.

15. The method according to claim 12, wherein the step of arranging the second press-on surface comprises the step of extending the second press-on surface at least partly along a radially outwardly extending flange part of the shaft-like body.

16. The method according to claim 12, wherein the step of connecting comprises separately connecting the fibers and the inner lining of the composite wall with the sealing ring at at least a part of the connecting locations.

17. The method according to claim 12, further comprising the steps of:
providing a cylindrical channel in which a cylindrical part of the shaft-like body is slidably received in the sealing ring; and
receiving in at least one groove in the cylindrical channel an O-ring for sealing in a gas-tight manner the intermediate space between the channel and the cylindrical part of the shaft-like body.
